(19) United States
(12) Patent Application Publication
(10) Pub. No.: US 2009/0219252 A1
(43) Pub. Date: Sep. 3, 2009

(54) APPARATUS, METHOD AND COMPUTER PROGRAM PRODUCT FOR MOVING CONTROLS ON A TOUCHSCREEN

(75) Inventors: Heli Margit Jarventie, Tampere (FI); Laura Katariina Jurvanen, Espoo (FI); Kirsi-Maria Hiltunen, Paavola (FI); Mikko Antero Nurmi, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/039,331

(22) Filed: Feb. 28, 2008

(51) Int. Cl. G06F 3/041

(52) U.S. Cl. 345/173

(57) ABSTRACT

An apparatus, method and computer program product are provided for facilitating blind usage of an electronic device having a touchscreen. The electronic device may sense the location of a user's finger on the touchscreen and generate, at that location, an output associated with an object capable of being selected. Generating the output may include displaying an icon and/or generating a sensation associated with the object. Alternatively, generating an output may include generating a sensation or tactile feedback that guides the user to the location of an icon associated with the object. In addition, or alternatively, each of a plurality of objects may have a different sensation associated therewith. The electronic device may output the sensation of the various objects upon receipt of a tactile input at different locations on the touchscreen, so that the user can move his or her finger around the touchscreen until he can feel the desired object.

### FIELD

Embodiments of the invention relate, generally, to touch sensitive input devices and, in particular, to facilitating blind usage of a touch sensitive input device.

### BACKGROUND

Touch sensitive input devices, such as touchscreens or other user interfaces that are based on touch, require that a user tap the touchscreen, for example using the user's finger, stylus, pen, pencil, or other selection device, proximate the location where an object (e.g., an icon) is displayed on the touchscreen in order to control the corresponding electronic device (e.g., cellular telephone, personal digital assistant (PDA), etc.). These touch-based controls often replace commands previously given to the electronic device by pressing, or otherwise actuating, the hard keys of the device. In fact, in some devices there may not be any hard keys at all.

One benefit of hard keys is that they are always located in the same place, so that the user will always know where to find the various controls of the device. However, one disadvantage of hard keys is that controlling the device using a fixed keypad is often not very ergonomic and rarely supports either one-hand usage or both left and right hand usage of the device. In addition, navigating though menus using navigation keys typically requires great attention and accuracy. However, because hard keys are typically located in a separate area from the controllable objects, a user may have to choose between looking at the controls (i.e., the keypad) and looking at the controllable objects on the display.

While touchscreens, touch displays, or touch sensitive covers having touch-based controls can solve many of these problems, they currently do not solve all of them. In particular, one drawback of touchscreens, or other touch-controlled user interfaces or input devices, is that the control buttons and other items or objects displayed on the touchscreen tend to move around. For example, the shortcut displayed in order to access a particular application may be displayed along the left-hand side of the touchscreen. Once launched, the toolbar used to execute various functions within the application may be displayed along the top of the touchscreen. Specific functions of the toolbar may further have dropdown menus that further display sub-functions below the toolbar, as well as additional sub-functions to the left or right of the dropdown menu. At the same time, other applications may display their toolbars, functions and sub-functions in different areas of the touchscreen or touch display. This movement of control buttons and other items or objects displayed on the touch sensitive input device or touchscreen may cause confusion and lessen the usability of the electronic device. In addition, this movement and the resulting inability of a user to memorize or automatically know the location of different objects or items displayed on the touchscreen lessens the possibility of blind usage of the electronic device, or the ability to access and manipulate different applications or functions of the device without looking. Although it's known in some computer applications to automatically move the cursor of a mouse to an “okay” button of a dialogue box, this does not appear to address the problems mentioned above with regard to hard and soft keys.

A need, therefore, exists for a technique that would improve a user's ability to blindly use his or her electronic device having a touch sensitive input device or touchscreen.

### BRIEF SUMMARY

In general, embodiments of the present invention provide an improvement by, among other things, enabling a user to more easily and accurately use his or her electronic device (e.g., cellular telephone, personal digital assistant (PDA), laptop, etc.) having a touch sensitive input device or touchscreen without having to repeatedly and/or continuously look at the electronic device touchscreen. In particular, in one embodiment of the present invention, the electronic device may sense the location of a user's finger, or other selection device (e.g., stylus, pen, pencil, etc.), on the electronic device touchscreen or above the touchscreen surface and then generate, at that location, an output associated with an item or object capable of being selected. The orientation of the output, or the output itself, may be determined based on an anticipated action by the user. For example, according to one embodiment, the item or object may be a shortcut associated with launching a particular application on the electronic device and/or a control button associated with an application already being executed on the electronic device, wherein the shortcut or control button is determined based, for example, on the frequency with which the user has executed that shortcut or control button. Alternatively, or in addition, the item or object may be a dialogue box, for example associated with an incoming message, wherein the orientation of the dialogue box is such that the user's finger (or other selection device) is on top of the button used to take some action with respect to the dialogue box, such as accept or receive the incoming message (e.g., an “okay” button).

In one embodiment, generating an output associated with the item or object at the determined location of the user's finger (or other selection device) may include displaying an icon at that location and/or generating a sensation or tactile feedback associated with the item or object at that location. In another embodiment, generating an output may include generating a sensation or tactile feedback that guides the user to the location of an icon associated with the item or object (e.g., points the user in the direction of the icon from the current location of the user's finger). In yet another embodiment, each of a plurality of items or objects may have a different sensation or tactile feedback associated therewith. The electronic device may output the tactile feedback of the various items or objects when a tactile feedback is detected at different locations on the touchscreen, so that the user can move his or her finger around on the touchscreen until he can feel the desired item or object.

In accordance with one aspect, an apparatus is provided for moving a control on a touch sensitive input device. In one embodiment, the apparatus may include a processor configured to: (1) detect a tactile input on a touch sensitive input device; (2) determine a location of the tactile input; and (3) cause an output to be generated proximate the determined location, wherein at least one of an orientation of the output or the output itself is determined based at least in part on an anticipated action by a user.

In accordance with another aspect, a method is provided for moving a control on a touch sensitive input device. In one embodiment, the method may include: (1) detecting a tactile input on a touch sensitive input device; (2) determining a location of the tactile input; and (3) causing an output to be generated proximate the determined location, wherein at least one of an orientation of the output or the output itself is determined based at least in part on an anticipated action by a user.

According to yet another aspect, a computer program product is provided for moving a control on a touch sensitive input device. The computer program product contains at least one computer-readable storage medium having computer-readable program code portions stored therein. The computer-readable program code portions of one embodiment include: (1) a first executable portion for detecting a tactile input on a touch sensitive input device; (2) a second executable portion for determining a location of the tactile input; and (3) a third executable portion for causing an output to be generated proximate the determined location, wherein at least one of an orientation of the output or the output itself is determined based at least in part on an anticipated action by a user.

In accordance with another aspect, an apparatus is provided for moving a control on a touch sensitive input device. In one embodiment, the apparatus may include: (1) means for detecting a tactile input on a touch sensitive input device; (2) means for determining a location of the tactile input; and (3) means for causing an output to be generated proximate the determined location, wherein at least one of an orientation of the output or the output itself is determined based at least in part on an anticipated action by a user.

According to yet another aspect, an apparatus is provided for generating tactile feedback associated with a control button. In one embodiment, the apparatus may include a processor configured to: (1) associate a tactile feedback with a control button; (2) detect a tactile input on a touch sensitive input device at a location associated with the control button; and (3) output the tactile feedback, in response to detecting the tactile input at the location, such that a user can determine the location of and select the control button based on the tactile feedback output.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of an entity capable of operating as an electronic device having a touch sensitive input device in accordance with embodiments of the present invention;

FIG. 2 is a schematic block diagram of a mobile station capable of operating in accordance with an embodiment of the present invention;

FIG. 3 is a flow chart illustrating the steps that may be taken in order to facilitate blind usage of an electronic device having a touchscreen in accordance with an embodiment of the present invention;

FIGS. 4A and 4B illustrate touchscreens capable of generating outputs based on the location of a tactile input in accordance with embodiments of the present invention;

FIG. 5 is a flow chart illustrating the steps that may be taken in order to dynamically provide a dialogue box associated with an incoming message based on the location of a user's finger or other selection device in accordance with an embodiment of the present invention;

FIGS. 6A and 6B illustrate touchscreens wherein the dialogue box has been dynamically provided in accordance with an embodiment of the present invention; and

FIG. 7 is a flow chart illustrating the steps that may be taken in order to guide a user to the location of an icon associated with a desired item or object in accordance with embodiments of the present invention.

### DETAILED DESCRIPTION

Embodiments of the present invention now will be described more fully hereinafter with reference to the accompanying drawings, in which some, but not all embodiments of the inventions are shown. Indeed, embodiments of the invention may be embodied in many different forms and should not be construed as limited to the embodiments set forth herein; rather, these embodiments are provided so that this disclosure will satisfy applicable legal requirements. Like numbers refer to like elements throughout.

### Overview:

In general, embodiments of the present invention provide an apparatus, method and computer program product for facilitating blind usage of an electronic device having a touch sensitive input device or touchscreen. In particular, according to one embodiment of the present invention, the electronic device may sense the location of a user's finger, or other selection device (e.g., stylus, pen, pencil, etc.), on the electronic device touchscreen and then generate, at that location, an output that is associated with an item or object capable of being selected, wherein the orientation of the output or the output itself may be determined based on an anticipated action by the user. Embodiments of the present invention relate to various types of items or objects, various types of outputs, as well as various anticipated actions by the user.

For example, according to one embodiment, the item or object in association with which an output is generated may be a shortcut for launching a particular application on the electronic device and/or a control button used after the application has already been executed. The shortcut and/or control button for which an output is generated may be determined based, for example, on the frequency with which the user has executed that shortcut or control button. In other words, in this embodiment, the anticipated action of the user may be selection of a frequently used shortcut or control button. For example, if the contacts application on the user's cellular telephone or PDA is the most frequently accessed application, an output may be generated beneath the user's finger (or other selection device) that is associated with launching the contacts application. Similarly, if after launching a web browser application, the user most frequently seeks to navigate to a particular website, an output associated with a navigation bar or similar control button, may be generated underneath the user's finger (or other selection device).

In one embodiment, generating an output associated with the item or object at the location of the user's finger (or other selection device) may include displaying an icon that is associated with the item or object underneath the user's finger (or other selection device). Alternatively, or in addition, generating the output may include generating a sensation or haptic/tactile feedback associated with the item or object underneath the user's finger, wherein the sensation may include, for example, a slippery, rubbery or furry feeling, or the like. If the user does not select the item or object corresponding to the generated output (e.g., he or she does not launch the contacts application in response to an icon and/or sensation associated with the contacts application being generated underneath his or her finger), according to one embodiment, the electronic device may generate a different output that is associated with another item or object (e.g., display an icon and/or generate a sensation that is associated with launching the next most popular application).

In another embodiment, instead of displaying the icon and/or generating the sensation corresponding to the item or object underneath the user's finger, generating an output may include generating a sensation or haptic/tactile feedback that guides the user to the location of the icon associated with the item or object (e.g., points the user in the direction of the icon from the current location of the user's finger). For example, if the shortcut to the contacts application (e.g., the “expected item”) is located above the user's finger, an upward sensation may be generated underneath the user's finger that indicates to the user that he or she needs to move his or her finger up in order to launch the contacts application.

According to yet another embodiment, the item or object in association with which an output is generated may be a dialogue box, for example associated with an incoming message. In this embodiment, the orientation of the dialogue box may be such that the user's finger (or other selection device) is substantially on top of an “okay” button of the dialogue box used to access or otherwise take some action with regard to the dialogue box (e.g., accept or receive the incoming message). In other words, in this embodiment, the anticipated action by the user may be, for example, acceptance of the message.

In yet another embodiment, each of a plurality of items or objects may have a different sensation or tactile feedback associated therewith. The electronic device may output the tactile feedback of the various items or objects when a tactile input is detected at different locations on the touchscreen. In other words, when a tactile input is detected at a location associated with one of the items, the tactile feedback associated with that item may be generated. Similarly, when a tactile input is detected at the location associated with another item, the tactile feedback associated with that item may be generated. In this manner, the user can move his or her finger around on the touchscreen until he or she can feel the tactile feedback associated with the desired item or object.

### Electronic Device:

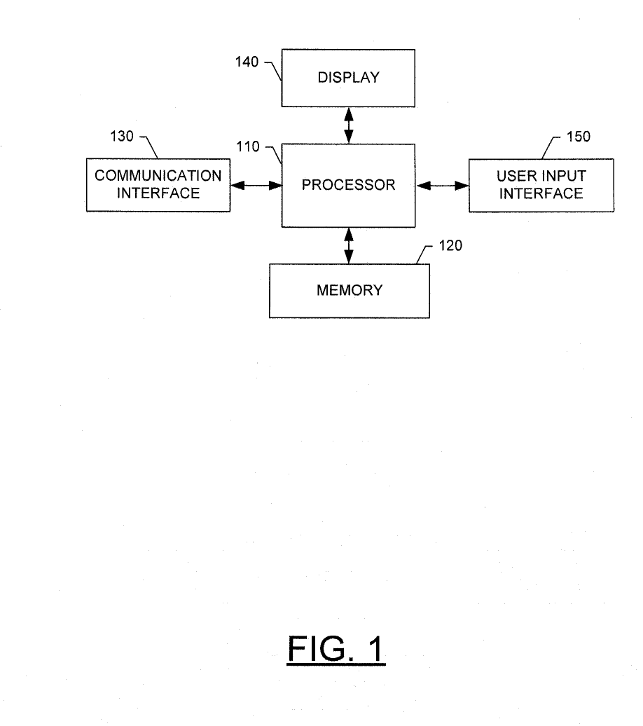

Referring now to FIG. 1, a block diagram of an entity capable of operating as an electronic device (e.g., cellular telephone, personal digital assistant (PDA), etc.) in accordance with one embodiment of the present invention is shown. The entity capable of operating as the electronic device includes various means for performing one or more functions in accordance with embodiments of the present invention, including those more particularly shown and described herein. It should be understood, however, that one or more of the entities may include alternative means for performing one or more like functions, without departing from the spirit and scope of the present invention. As shown, the entity capable of operating as the electronic device can generally include means, such as a processor 110 for performing or controlling the various functions of the entity.

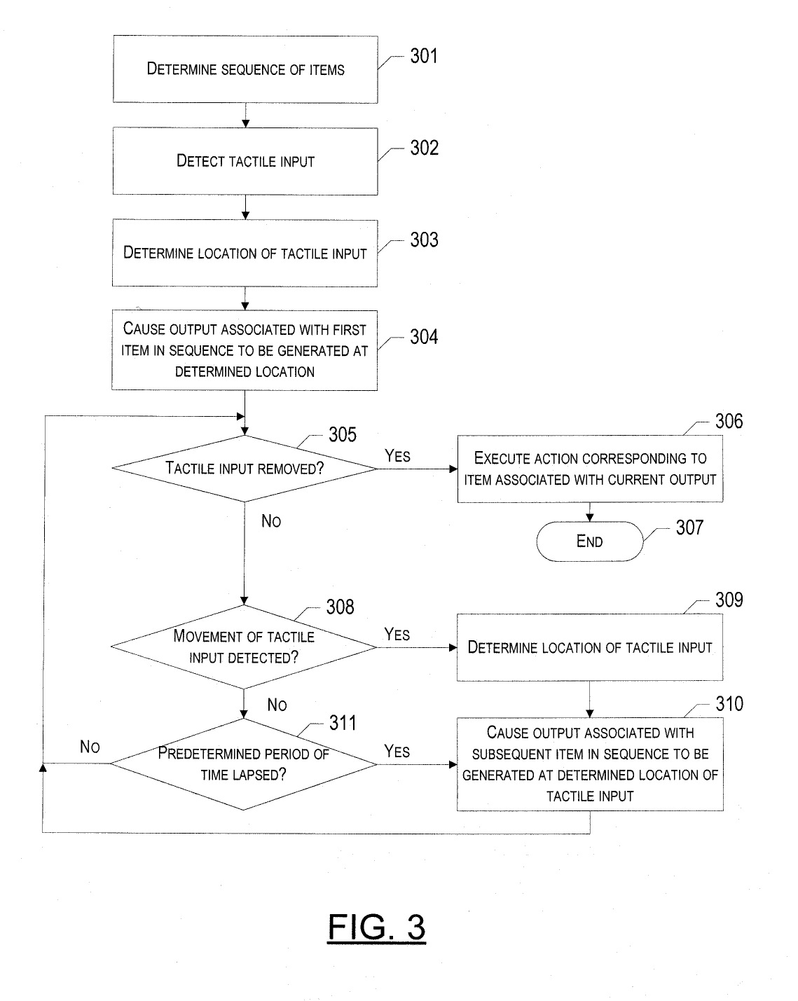

In particular, the processor 110, or similar means, may be configured to perform the processes discussed in more detail below with regard to FIGS. 3, 5 and 7. For example, the processor 110 may be configured to detect a tactile input on a touch sensitive input device associated with the electronic device, to determine a location of the tactile input, and to cause an output to be generated proximate the determined location, wherein the orientation of the output, or the output itself, may be determined based at least in part on an anticipated action of the user of the electronic device. Alternatively, or in addition, the processor 110 may be configured to associate a tactile feedback with a control button and to detect a tactile input on a touch sensitive input device at a location associated with the control button. The processor 110 may thereafter be configured to output the tactile feedback in response to detecting the tactile input at the location, such that a user can determine the location of and select the control button based on the tactile feedback output.

In one embodiment, the processor is in communication with or includes memory 120, such as volatile and/or non-volatile memory that stores content, data or the like. For example, the memory 120 typically stores content transmitted from, and/or received by, the entity. Also for example, the memory 120 typically stores software applications, instructions or the like for the processor to perform steps associated with operation of the entity in accordance with embodiments of the present invention. In particular, the memory 120 may store computer-readable program code for instructing the processor to perform the processes described above and below with regard to FIGS. 3, 5 and 7 for facilitating blind usage of the electronic device.

In addition to the memory 120, the processor 110 can also be connected to at least one interface or other means for displaying, transmitting and/or receiving data, content or the like. In this regard, the interface(s) can include at least one communication interface 130 or other means for transmitting and/or receiving data, content or the like, as well as at least one user interface that can include a display 140 and/or a user input interface 150. The user input interface, in turn, can comprise any of a number of devices allowing the entity to receive data from a user, such as a keypad, a touchscreen or display, a joystick or other input device.

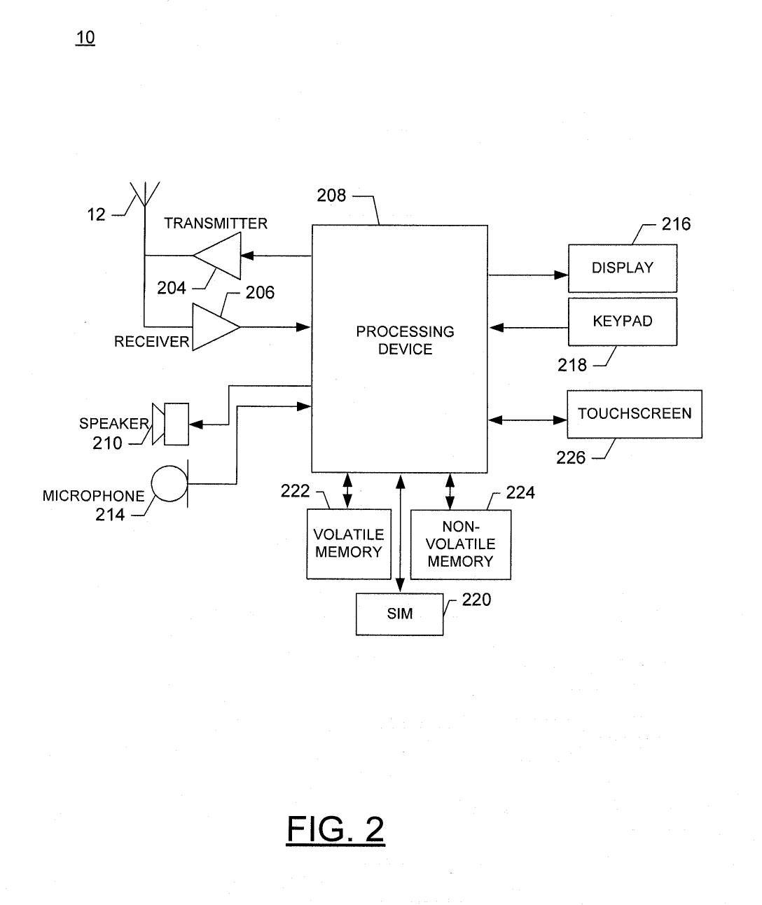

Reference is now made to FIG. 2, which illustrates one type of electronic device that would benefit from embodiments of the present invention. As shown, the electronic device may be a mobile station 10, and, in particular, a cellular telephone. It should be understood, however, that the mobile station illustrated and hereinafter described is merely illustrative of one type of electronic device that would benefit from the present invention and, therefore, should not be taken to limit the scope of the present invention. While several embodiments of the mobile station 10 are illustrated and will be hereinafter described for purposes of example, other types of mobile stations, such as personal digital assistants (PDAs), pagers, laptop computers, or other mobile stations having touch-sensitive input devices, as well as other types of electronic systems including both mobile, wireless devices and fixed, wireline devices, can readily employ embodiments of the present invention.

The mobile station includes various means for performing one or more functions in accordance with embodiments of the present invention, including those more particularly shown and described herein. It should be understood, however, that the mobile station may include alternative means for performing one or more like functions, without departing from the spirit and scope of the present invention. More particularly, for example, as shown in FIG. 2, in addition to an antenna 202, the mobile station 10 includes a transmitter 204, a receiver 206, and an apparatus that includes means, such as a processing device 208, e.g., a processor, controller or the like, that provides signals to and receives signals from the transmitter 204 and receiver 206, respectively, and that performs the various other functions described below including, for example, the functions relating to facilitating blind usage of the mobile station.

As discussed in more detail below with regard to FIGS. 3, 5 and 7, in one embodiment, the processor 208 may be configured to detect a tactile input on the touch sensitive input device of the mobile station, to determine a location of the tactile input, and to then cause an output to be generated proximate the determined location, wherein at least one of the orientation of the output, or the output itself, is determined based at least in part on an anticipated action by the user. The processor 208 may be further configured to determine a sequence of one or more items or objects (e.g., shortcuts to applications, control buttons, etc.), wherein causing the output to be generated may involve displaying an icon and/or generating a tactile feedback associated with a first item of the sequence of items. The processor 208 may thereafter be configured to display an icon and/or generate a tactile feedback associated with a subsequent item of the sequence of items, if either the tactile feedback is still detected after a predetermined period of time or a movement of the tactile feedback to a different location is detected (e.g., the user moved his or her finger without lifting his or her finger from the touchscreen). In the latter instance, the processor 208 may be configured to display the icon and/or generate the tactile feedback associated with the subsequent item at the new or different location.

In addition, according to another embodiment the processor may be further configured to cause a dialogue box, for example associated with the message, to be displayed, wherein the orientation of the dialogue box is such that the portion of the dialogue box that must be actuated in order to access or otherwise take some action with respect to the dialogue box, such as accept or receive the incoming message, (e.g., an “okay” button) may be displayed proximate the determined location of the tactile feedback. In other words, in order to cause an output to be generated, the processor 208 may be configured to display a dialogue box, wherein the orientation of the dialogue box is determined based on an anticipated action by the user (e.g., acceptance or receipt of the corresponding incoming message).

In yet another embodiment, the processor 208 may be further configured to determine a location of an icon associated with expected item or object (e.g., of an icon associated with an application it is anticipated that the user would like to launch), to determine the direction of the icon from the location of the tactile feedback, and to then generate a sensation or tactile feedback that indicates the determined location. In other words, in order to cause an output to be generated, the processor 208 may be configured to generate a tactile feedback that directs the user toward an icon associated with the item or object it is anticipated that the user would like to actuate.

In another embodiment, the processor 208 may be configured to associate a tactile feedback with a control button and to detect a tactile input on a touch sensitive input device at a location associated with the control button. The processor 208 may thereafter be configured to output the tactile feedback in response to detecting the tactile input at the location, such that a user can determine the location of and select the control button based on the tactile feedback output

As one of ordinary skill in the art would recognize, the signals provided to and received from the transmitter 204 and receiver 206, respectively, may include signaling information in accordance with the air interface standard of the applicable cellular system and also user speech and/or user generated data. In this regard, the mobile station can be capable of operating with one or more air interface standards, communication protocols, modulation types, and access types. More particularly, the mobile station can be capable of operating in accordance with any of a number of second-generation (2G), 2.5G and/or third-generation (3G) communication protocols or the like. Further, for example, the mobile station can be capable of operating in accordance with any of a number of different wireless networking techniques, including Bluetooth, IEEE 802.11 WLAN (or Wi-Fi®), IEEE 802.16 WiMAX, ultra wideband (UWB), and the like.

It is understood that the processing device 208, such as a processor, controller or other computing device, may include the circuitry required for implementing the video, audio, and logic functions of the mobile station and may be capable of executing application programs for implementing the functionality discussed herein. For example, the processing device may be comprised of various means including a digital signal processor device, a microprocessor device, and various analog to digital converters, digital to analog converters, and other support circuits. The control and signal processing functions of the mobile device are allocated between these devices according to their respective capabilities. The processing device 208 thus also includes the functionality to convolutionally encode and interleave message and data prior to modulation and transmission. Further, the processing device 208 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile station may also comprise means such as a user interface including, for example, a conventional earphone or speaker 210, a microphone 214, a display 216, all of which are coupled to the controller 208. The user input interface, which allows the mobile device to receive data, can comprise any of a number of devices allowing the mobile device to receive data, such as a keypad 218, a touch-sensitive input device, such as a touchscreen or touchpad 226, a microphone 214, or other input device. In embodiments including a keypad, the keypad can include the conventional numeric (0-9) and related keys (#, *), and other keys used for operating the mobile station and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile station can also include means, such as memory including, for example, a subscriber identity module (SIM) 220, a removable user identity module (R-UIM) (not shown), or the like, which typically stores information elements related to a mobile subscriber. In addition to the SIM, the mobile device can include other memory. In this regard, the mobile station can include volatile memory 222, as well as other non-volatile memory 224, which can be embedded and/or may be removable. For example, the other non-volatile memory may be embedded or removable multimedia memory cards (MMCs), secure digital (SD) memory cards, Memory Sticks, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device.

The memory 222 can also store content. The memory 222 may, for example, store computer program code for an application and other computer programs. For example, in one embodiment of the present invention, the memory 222 may store computer program code for detecting a tactile input on the touchscreen 226, determining a location of the tactile input, and then causing an output to be generated at the determined location, wherein at least one of the orientation of the output or the output itself is determined based at least in part on an anticipated action by a user of the mobile station 10. In another embodiment, the memory 222 may store computer program code for associating a tactile feedback with a control button and detecting a tactile input on touchscreen 226 at a location associated with the control button. The memory 222 may further store computer program code for outputting the tactile feedback in response to detecting the tactile input at the location, such that a user can determine the location of and select the control button based on the tactile feedback output.

The apparatus, method and computer program product of embodiments of the present invention are primarily described in conjunction with mobile communications applications. It should be understood, however, that the apparatus, method and computer program product of embodiments of the present invention can be utilized in conjunction with a variety of other applications, both in the mobile communications industries and outside of the mobile communications industries. For example, the apparatus, method and computer program product of embodiments of the present invention can be utilized in conjunction with wireline and/or wireless network (e.g., Internet) applications.

### Methods of Facilitating Blind Usage of Electronic Device

Referring now to FIG. 3, the operations are illustrated that may be taken in order to facilitate blind usage of an electronic device in accordance with embodiments of the present invention. As shown, the process may begin at Block 301 when the electronic device and, in particular, a processor or similar means operating on the electronic device determines a sequence of items or objects to be used when determining which outputs should be generated in response to the user touching the touchscreen of the electronic device. In particular, as discussed above, the items or objects may include shortcuts associated with launching various applications, control buttons that may be used once an application has been launched or executed, and/or the like. In one embodiment, determining a sequence of these items or objects may involve receiving a user-defined sequence of items or objects. For example, the user may specify that when he or she touches the touchscreen in an area where no icons are displayed and/or when the electronic device is in a particular mode (e.g., a “blind usage mode”), shortcuts associated with a particular group of applications should be generated underneath his or her finger (or other selection device) and in a particular order. The user-defined sequence may include, for example, the shortcuts associated with a contacts application, a web browser, a music player and a speed dial application, in that order.

In another embodiment, the sequence of items or objects may be determined based on a historic frequency of execution of the items or objects and/or an order in which the items or objects are frequently executed. In other words, the electronic device (e.g., processor or similar means operating thereon) may monitor not only the frequency of use of various shortcuts and/or control buttons but also the succession of shortcuts and/or control buttons selected. For example, the sequence may include a plurality of frequently executed applications in order of the most frequently executed to the least frequently executed. Similarly, the order of a sequence of control buttons may correspond not only to the frequency of execution, but also the order in which the control buttons are more frequently executed.

As one of ordinary skill in the art will recognize, while the foregoing describes determining “a” sequence of items or objects, multiple sequences of items or objects may be generated for use at different instances of use of the electronic device. In other words, multiple sequences of items or objects may be generated so that the most appropriate output can be generated given the current status of the electronic device and the applications executing thereon. For example, a sequence of applications may be generated for use when the electronic device is in idle mode (i.e., no applications are currently being executed), while another sequence of control buttons associated with each of the applications capable of being executed on the electronic device may further be generated for use when the corresponding application is being executed. Similarly, a sequence may be defined, for example, for when a particular application has been executed and one or more control buttons associated with that application have been actuated. In other words, according to embodiments of the present invention multiple hierarchical sequences of items or objects may be generated.

At some point after determining the sequences, the user may touch the touchscreen of the electronic device in order to utilize the blind usage features described herein. In one embodiment, at the time the user touches the touchscreen, the electronic device may be in idle mode. Alternatively, the electronic device may have been specifically placed in a blind usage mode. In either case, according to one embodiment, the user may touch the touchscreen at any location on the touchscreen, regardless of what may be displayed on the electronic device touchscreen. Alternatively, the electronic device may be in its regular mode of operation, wherein various icons associated with various items or objects may currently be displayed, for example, in their default locations. In this instance, according to one embodiment, the user may be required to touch the touchscreen at a location at which no icons, or the like, are displayed (e.g., in a blank area).

In response to the user touching the touchscreen, the electronic device (e.g., processor or similar means operating thereon) may, at Blocks 302 and 303, respectively, detect the tactile input and determine its location. The electronic device (e.g., the processor or similar means operating on the electronic device) may detect the tactile input and determine its location via any number of techniques that are known to those of ordinary skill in the art. For example, the touchscreen may comprise two layers that are held apart by spacers and have an electrical current running there between. When a user touches the touchscreen, the two layers may make contact causing a change in the electrical current at the point of contact. The electronic device may note the change of the electrical current, as well as the coordinates of the point of contact.

Alternatively, wherein the touchscreen uses a capacitive, as opposed to a resistive, system to detect tactile input, the touchscreen may comprise a layer storing electrical charge. When a user touches the touchscreen, some of the charge from that layer is transferred to the user causing the charge on the capacitive layer to decrease. Circuits may be located at each corner of the touchscreen that measure the decrease in charge, such that the exact location of the tactile input can be calculated based on the relative differences in charge measured at each corner. Embodiments of the present invention can employ other types of touchscreens, such as a touchscreen that is configured to enable touch recognition by any of resistive, capacitive, infrared, strain gauge, surface wave, optical imaging, dispersive signal technology, acoustic pulse recognition or other techniques, and to then provide signals indicative of the location of the touch.

The touchscreen interface may be configured to receive an indication of an input in the form of a touch event at the touchscreen. As suggested above, the touch event may be defined as an actual physical contact between a selection device (e.g., a finger, stylus, pen, pencil, or other pointing device) and the touchscreen. Alternatively, a touch event may be defined as bringing the selection device in proximity to the touchscreen (e.g., hovering over a displayed object or approaching an object within a predefined distance).

In response to detecting the tactile input and determining its location, the electronic device (e.g., processor or similar means operating on the electronic device) may cause an output associated with a first item in the sequence of items to be generated at the determined location. (Block 304). As discussed above, according to one embodiment, causing the output to be generated may involve displaying an icon associated with the item or object. Alternatively, or in addition, causing the output to be generated may involve generating a sensation or haptic/tactile feedback that is associated with the item or object underneath the user's finger. Sensations may include for example, a furry, rubbery, fluffy or slimy feeling, various vibrations including, for example, a vibration that mimics a machine gun, snoring, a heartbeat, or the like. For example, each of the control buttons of a music player may have a different sensation associated therewith. These sensations may include, for example, a jumping up or down feeling for the volume button, a sliding right feeling for the next track button, a sliding left feeling for the previous track button and the like. As one of ordinary skill in the art will recognize, sensations of the kind described herein may be generated using, for example, the techniques disclosed in U.S. Pat. No. 6,429,846 assigned to Immersion Corporation (“the Immersion patent”).

At this point the user may select the item or object with which the generated output is associated (e.g., launch the application associated with a displayed shortcut) by, for example, lifting his or her finger or other selection device. If it is determined, at Block 305, that the tactile input has been removed (i.e., that the user has lifted his or her finger or other selection device), the electronic device (e.g., processor or similar means operating on the electronic device) may execute the action corresponding to the item, and the process may end (Block 307). In one embodiment, the electronic device (e.g., processor or similar means) may further output a sound, such as a short beep, upon execution of the action in order to notify the user that an action has been taken.

If, on the other hand, the user does not want to select the item or object with which the current output is associated, according to embodiments of the present invention, other choices may be provided to the user for his or her selection. In particular, according to one embodiment, the user may simply move his or her finger (or other selection device) without removing the finger (or other selection device) from the electronic device touchscreen. If, at Block 308, movement of the tactile input is detected, the electronic device (e.g., processor or similar means operating on the electronic device) may determine the new (or different) location of the tactile input (Block 309) and then cause an output associated with a subsequent item in the sequence of items to be generated at the new or different location (Block 310). In one embodiment of the present invention, the distance the user moves his or her finger (or other selection device) may determine with which of the subsequent items of the sequence of items the generated output is associated. For example, if the first item or object was a control button for answering an incoming call, the user may reject the call by moving his or her finger (or other selection device) two to four centimeters in any direction and then lift his or her finger (or other selection device) or silence the call by moving his or her finger (or other selection device) four to six centimeters in any direction and then lift his or her finger (or other selection device).

The output associated with the subsequent item may include, for example, an icon of a different size, color, shape and/or design. Alternatively, or in addition, the output may include a different sound and/or a different tactile feedback than that of the output associated with the first or previous item. The process may then return to Block 305 where it may again be determined whether the tactile input has been removed (i.e., whether the user has selected the new item or object associated with the new output) and, if not, whether the user has again moved his or her finger (or other selection device). The user may continue this sequence until an output associated with the desired item or object is generated.

To illustrate, assume that the user is currently within the speed dial application of his or her electronic device and further that he or she has selected “Aaron” as the person he or she would like to contact. The sequence of items determined at Block 301 for this instance may include voice call, video call, text message, email, and so on. When the user first touches the screen, an icon and/or sensation associated with the voice call command may be generated underneath the user's finger or other selection device. If the user wishes to transmit a text message (instead of initiating a voice call), he or she may move his or finger (or other selection device) causing the output to change to an icon and/or sensation associated with a video call. He or she may continue this movement until the correct command or control button is output underneath his or her finger (or other selection device).

Another way in which the user may request that an output associated with a subsequent item or object in the sequence of items be generated may be to simply leave his or her finger (or other selection device) on the touch sensitive input device. According to this embodiment, if it is determined, at Block 308, that the user has not moved his or her finger (or other selection device), it may then be determined whether a predetermined period of time has lapsed since the output was generated. If the predetermined period of time has lapsed, the electronic device (e.g., processor or similar means operating on the electronic device) may, at Block 310, cause an output associated with a subsequent item in the sequence of items to be generated at the location of the tactile input (i.e., underneath the user's finger or other selection device).

If, on the other hand, the predetermined period of time has not lapsed, as determined at Block 311, the process may return to Block 305 where it may again be determined whether the user has selected the item or object associated with the generated output (i.e., whether the tactile input has been removed). As above, this process may continue until the output generated corresponds to the desired item or object. In other words, the user may touch the touchscreen and then leave his or her finger or other selection device on the touchscreen while the outputs generated underneath his or her finger or other selection device change until the generated output corresponds to the application, control button, or the like, the user desires to select.

While not shown, if at some point the user decides that he or she does not want to launch an application, actuate a control button, or take any other action with regard to items or objects for which outputs have been generated, the user may cancel all actions by, for example, moving his or her finger (or other selection device) from the touchscreen area altogether (e.g., to the edge of the device with no display) and then lift his or her finger (or other selection device) only after it has been moved.

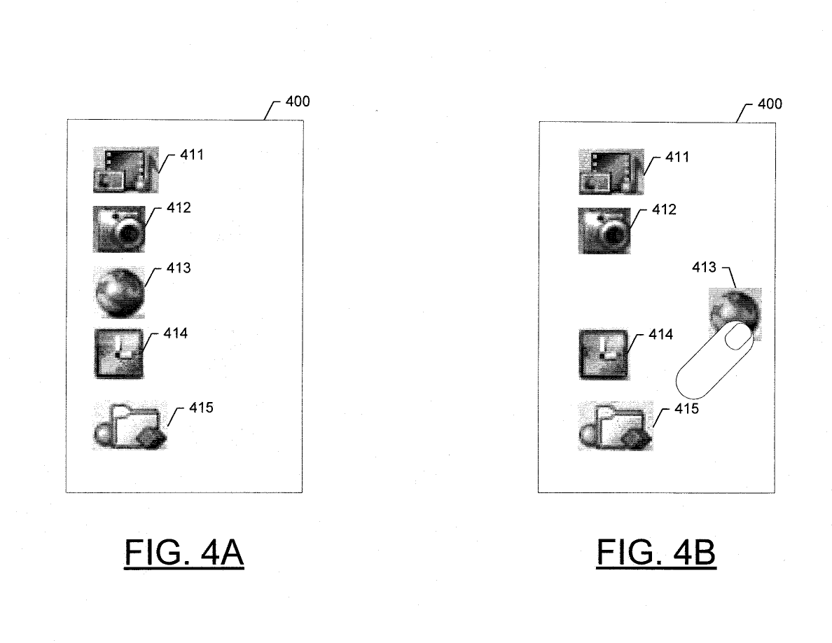

Reference is now made to FIGS. 4A and 4B, which provide an illustration of a touch sensitive input device or touchscreen 400 before (FIG. 4A) and after (FIG. 4B) the user has touched the touchscreen 400 in accordance with embodiments of the preset invention. As shown, the touchscreen 400 may display one or more icons 411, 412, 413, 414, 415 representing shortcuts to various applications executable on the electronic device. When the user places his or her finger 420 on the touchscreen 400, for example, at a location at which none of the icons is displayed, one of the icons 413 may be moved to underneath his or her finger 420, so that the user can simply remove his or her finger 420 in order to launch the application associated with the moved icon 413.

As one of ordinary skill in the art will recognize, while FIGS. 4A and 4B illustrate movement of an already displayed icon to a position underneath the user's finger, it is not necessary that the output generated in response to the user touching the touchscreen correspond to an item or object already represented on the electronic device touchscreen. In contrast, an icon may be displayed and/or a sensation generated that is associated with a different item or object, not otherwise represented on the electronic device touchscreen.

For illustration purposes, the following provides an example of how embodiments of the present invention may be used. As one of ordinary skill in the art will recognize, the following example is provided for exemplary purposes only and should not be taken in any way as limiting embodiments of the present invention to the scenario described. In this example, a user may feel tired while driving and want to cheer him- or herself up by listening to some music. Because he or she may want to concentrate on driving, the user may not look at his or her electronic device (e.g., cellular telephone) when he or she puts his or her finger down on an idle touchscreen. According to embodiments of the present invention, while the idle screen is empty when the user puts his finger down, an adaptive shortcut button may appear below the user's finger in response to the user's gesture. Since the user uses the Music player of this electronic device a lot, he or she may not need to wait for a long time before he or she can feel a furry circle below his or her finger. Because of prior settings, the user may know that a button with a furry circle corresponds to the Music player application. The user may then lift his or her finger up, and the Music player application may be launched.

The user may then place his or her finger down on the screen again. According to one embodiment, the user may again feel a furry button underneath his or her finger. This time, the user may know that the furry button corresponds to a play button. The user may then lift his or her finger up again, and the player may start playing the last played music track. If the user, for example, thinks that the currently playing track is too depressing, he or she may decide to change the track. To do so, the user may put his or her finger down again and wait until he or she can feel the tactile sensation associated with the button below his or her finger move to the right. The user may know that this sensation or tactile feedback corresponds to the skip track button. The user may then lift his or her finger up, and the music track may skip to the next one. If the user finds the new song appealing, he or she may simply relax and enjoy the song.

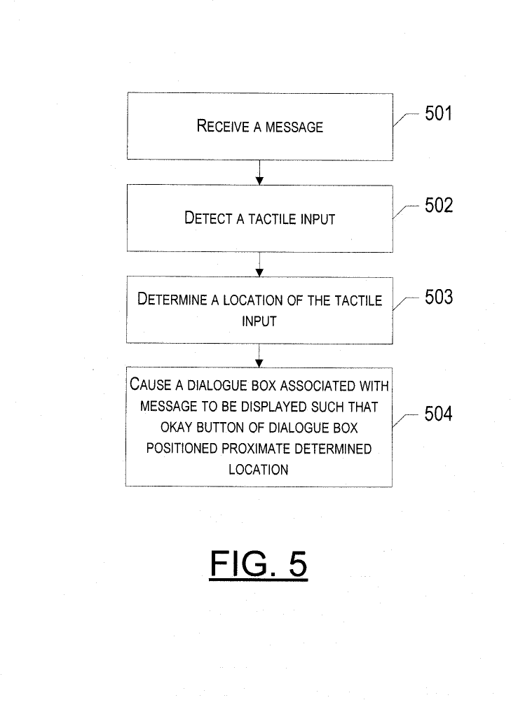

Reference is now made to FIG. 5, which illustrates the operations that may be taken in order to facilitate blind usage of an electronic device in accordance with another embodiment of the present invention. As shown, this process may begin at Block 501, when the electronic device, and in particular a processor or similar means operating on the electronic device, receives a message intended for the user of the electronic device. The message may include, for example, a text message (e.g., a Short Message Service (SMS) message), a multimedia message (e.g., a Multimedia Message Service (MMS) message), an email, or the like. The electronic device (e.g., processor or similar means operating on the electronic device) may then detect a tactile input on the electronic device touchscreen (at Block 502) and determine its location (at Block 503). In other words, the electronic device (e.g., processor or similar means) may detect, using any of the known methods described above with reference to FIG. 3, that the user is touching the touchscreen using his or her finger or other selection device and determine the location at which the user is touching the touchscreen.

Once the location of the user's finger (or other selection device) has been determined, the electronic device (e.g., processor or similar means operating on the electronic device) may cause a dialogue box associated with the message to be displayed on the touchscreen, wherein the orientation of the dialogue box is such that the portion of the dialogue box the user may select in order to accept or receive the message (e.g., the “okay” button) may be positioned proximate the determined location of the tactile input (e.g., substantially underneath the user's finger or other selection device). By doing so, the electronic device eliminates the need for the user to move his or her finger or other selection device in order to accept or receive the message.

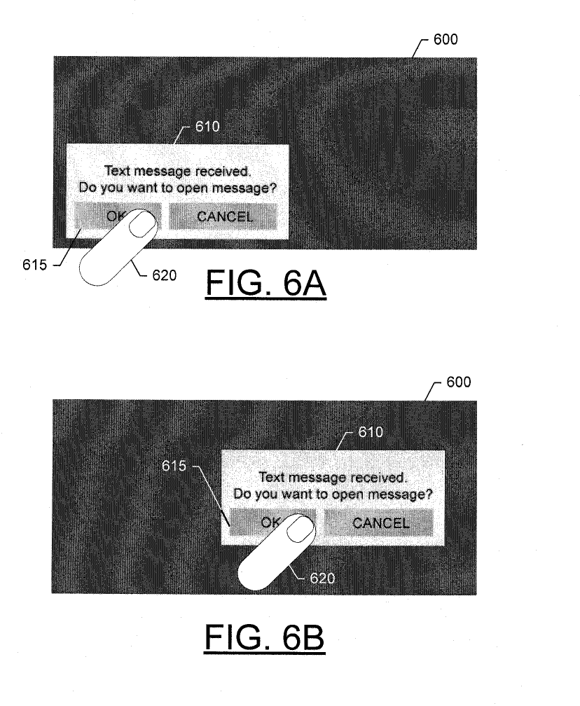

FIGS. 6A and 6B illustrate a touchscreen 600 wherein the dialogue box 610 associated with an incoming message is displayed at a different location depending upon the location of the user's finger 620. As shown, despite the fact that the user's finger 620 is located at a different location on the touchscreen 600 in FIG. 6A than the location in FIG. 6B, in each figure the location and the orientation of the dialogue box 610 is such that the user's finger 620 is on top of the “OK” button 615 of the dialogue box in both figures. As one of ordinary skill in the art will recognize, while the foregoing assumes that the dialogue box displayed proximate the location of the user's finger (or other selection device) is associated with an incoming message, embodiments of the present invention are not so limited. In particular, embodiments of the present invention provide for the display of any type of dialogue box capable of being accessed or otherwise selected.

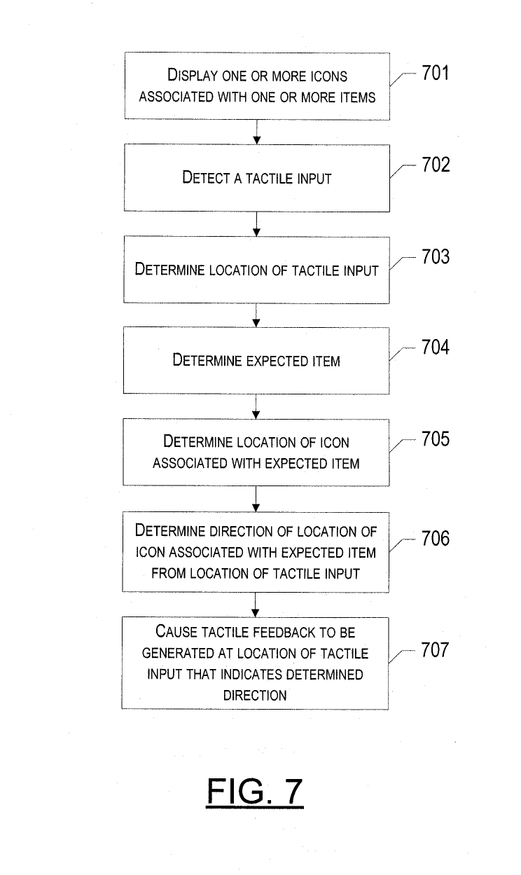

Referring now to FIG. 7, the operations that may be taken in order to facilitate blind usage of an electronic device are illustrated in accordance with yet another embodiment of the present invention. As shown, this process may begin at Block 701, when the electronic device, and in particular a processor or similar means operating on the electronic device, displays one or more icons associated with a corresponding one or more items or objects (e.g., shortcuts to launching an application, control buttons to be used during execution of an application, etc.).

At some point the user may touch the touchscreen intending to select one of the icons (and, therefore, to execute the corresponding item or object). The electronic device (e.g., processor or similar means operating on the electronic device) may detect the corresponding tactile input and determine its location, at Blocks 702 and 703, respectively. This may be done using any of the known methods described above with regard to FIG. 3.

In response to detecting the tactile input and determining its location, the electronic device (e.g., processor or similar means operating on the electronic device) may, at Block 704, determine which icon it is expected the user was intending to select, in other words, what is the “expected item.” As described above with regard to determining the sequence of items or objects, this may be determined based on user input, historic frequency of execution, or the like. For example, the user may specify that whenever the electronic device is in idle or blind usage mode, when the user touches the touchscreen, the electronic device should anticipate that the user wishes to launch the music player application. In this instance, the music player application may be considered the “expected item,” Alternatively, the electronic device (e.g., processor or similar means) may determine based on historic frequency of execution of various applications that the user most frequently wishes to execute the contacts application. In this instance, the expected item may be the contacts application.

Once the expected item has been determined, the electronic device (e.g., processor or similar means operating on the electronic device) may determine the location of the icon associated with the expected item (at Block 705), as well as the direction of the icon from the location of the detected tactile input (at Block 706). The electronic device (e.g., processor or similar means operating on the electronic device) may then cause a tactile feedback to be generated at the location of the tactile input that indicates the determined direction. (Block 707).

To illustrate, continuing with the first example above, if the user touches the touchscreen somewhere below the icon associated with the music player application, the determined direction may be up. As a result, the electronic device (e.g., processor or similar means) may generate a sensation or haptic/tactile feedback that guides the user upward. For example, the haptic feedback generated may start with a slight tap at the bottom of the user's fingertip and then move upward along the user's fingertip. Similarly, if it were determined that the icon associated with the expected item is displayed to the right of the user's finger, then the haptic feedback generated may include a tap beginning at the left side of the user's fingertip and then continuing to the right side of the user's fingertip. According to one embodiment, the frequency of the tactile feedback may correspond to the distance the user needs to move his or her finger (or other selection device) in order to reach the icon associated with the expected item (e.g., the closer the user's finger, or other selection device, is to the icon, the higher the frequency of the tactile feedback). Based on the haptic feedback provided to the user, the user may know in which direction he or she needs to move his or her finger in order to select the icon associated with the expected desired item.

In addition to the foregoing, according to yet another embodiment of the present invention, in order to facilitate blind usage of an electronic device having a touch sensitive input device or touchscreen, sensations or haptic/tactile feedbacks may be associated with various items or objects used to control the electronic device. In particular, each item or object (e.g., shortcut to launch an application, control button for use in executing the application, etc.) may have a different haptic/tactile feedback associated with it. For example, the shortcut used to launch a music player application may be associated with a furry feeling, while the shortcut used to access a contracts application may have a slimy feeling associated with it. As noted above, as one of ordinary skill in the art will recognize these sensations may be generated using, for example, the techniques described in the Immersion patent. According to this embodiment, the electronic device, and in particular the processor or similar means operating on the electronic device, may cause the various sensations to be generated when the user touches the touchscreen at different locations on the touchscreen, so that the user may move his or her finger around on the touchscreen until he or she can feel the desired item or object.

To illustrate, assume for example, that a user is attending an excellent concert and wishes to place a video call to his or her friend without having to miss a second of the concert. To do so, according to embodiments of the present invention, the user may place the call without having to look at his or her electronic device (e.g., cellular telephone). In particular, the user may first move his or her finger around on the touchscreen of the electronic device until he or she recognizes the sensation she has defined for the speed dial application (e.g., until he or she feels a slimy button generated based on the location of the user's touch). Once the user has found the button associated with the speed dial application, he or she may select or otherwise actuate the button. According to one embodiment, the user may have also defined different sensations for each speed dial contact. In this embodiment, the user may then move his or her finger within the speed dial grid until he or she finds the speed dial button associated with his or her friend. The user may then lift his or her finger up to select the friend.

In order to place the call the user may then place his or her finger back down again in order to select the manner in which the friend is contacted, for example, using the process described above with regard to FIG. 3. In particular, at this point, the user may feel different sensations associated with different manners in which he or she may contact the friend including, for example, a voice call, video call, text message, and the like. As described above, these sensations may automatically change over time if the user does not remove his or her finger, or the user may move his or her finger on the touchscreen, without lifting it, in order to feel the sensation associated with a subsequent application. In either event, the user may then lift his or her finger when he or she feels the sensation that is associated with placement of a video call. When the user does so, his or her electronic device may activate a video call with the user's friend.

These and other types of tactile feedbacks may further be used in conjunction with various games being played using the electronic device. For example, a game that tests a user's reaction speed may be executed, wherein the user is asked to press a button when he or she feels a furry button underneath his or her finger. Similarly, a game may be executed wherein the user is asked to pick a rose from a running line of flowers. In particular, different sensations or tactile feedbacks may be generated in association with a number of different types of flowers. When the user feels what he or she thinks corresponds to a rose underneath his or her finger, the user may lift his or her finger from the device touchscreen. If the user is correct, he or she may receive points, if not, he or she may lose points.

### CONCLUSION

As described above and as will be appreciated by one skilled in the art, embodiments of the present invention may be configured as an apparatus and method. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus, such as processor 110 discussed above with reference to FIG. 1, or processor 208 discussed above with reference to FIG. 2, to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus (e.g., processor 110 of FIG. 1 or 208 of FIG. 2) to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An apparatus comprising:
a processor configured to:
detect a tactile input on a touch sensitive input device;
determine a location of the tactile input; and
cause an output to be generated proximate the determined location, wherein at least one of an orientation of the output or the output itself is determined based at least in part on an anticipated action by a user.

2. The apparatus of claim 1, wherein the processor is further configured to:
determine a sequence of one or more items, and wherein in order to cause an output to be generated, the processor is further configured to cause an icon associated with a first item of the sequence of items to be displayed.

3. The apparatus of claim 2, wherein the sequence of items is determined based at least in part on a frequency of execution of respective items.

4. The apparatus of claim 2, wherein the sequence of items is determined based at least in part on user input received.

5. The apparatus of claim 2, wherein in order to cause an output to be generated, the processor is further configured to cause an icon associated with a subsequent item of the sequence of items to be displayed at the location if the tactile input is still detected after a predetermined period of time has lapsed.

6. The apparatus of claim 2, wherein the processor is further configured to:
detect a movement of the tactile input to a different location on the touch sensitive input device; and
cause an output to be generated at the different location, wherein the output comprises a display of an icon associated with a subsequent item of the sequence of items.

7. The apparatus of claim 6, wherein the processor is further configured to:
determine the distance of the movement detected; and
select the subsequent item from the sequence of items based at least in part on the determined distance.

8. The apparatus of claim 2, wherein respective items of the sequence of items have a different tactile feedback associated therewith, and wherein in order to cause an output to be generated the processor is further configured to cause the tactile feedback associated with an item of the sequence of items to be generated.

9. The apparatus of claim 2, wherein respective items comprise at least one of a shortcut to an application capable of being executed on the apparatus or a control button associated with execution of an application on the apparatus.

10. The apparatus of claim 1, wherein the processor is further configured to:
determine a location on the touch sensitive input device of an icon associated with an expected item; and
determine the direction of the determined location of the icon from the location of the tactile input, wherein in order to cause the output to be generated, the processor is further configured to cause a tactile feedback to be generated proximate the location of the tactile input that indicates the determined direction.

11. The apparatus of claim 1, wherein the processor is further configured to:
cause a dialogue box to be displayed, said dialogue box comprising a portion the user can select in order to access the dialogue box, and wherein in order to cause an output to be generated at the determined location, the processor is further configured to display the dialogue box such that the portion is proximate the determined location.

12. The apparatus of claim 11, wherein the processor is further configured to:
receive a message, wherein the dialogue box is associated with the message.

13. A method comprising:
detecting a tactile input on a touch sensitive input device;
determining a location of the tactile input; and
causing an output to be generated proximate the determined location, wherein at least one of an orientation of the output or the output itself is determined based at least in part on an anticipated action by a user.

14. The method of claim 13 further comprising:
determining a sequence of one or more items, wherein causing an output to be generated further comprises causing an icon associated with a first item of the sequence of items to be displayed.

15. The method of claim 14, wherein causing an output to be generated further comprises causing an icon associated with a subsequent item of the sequence of items to be displayed at the location if the tactile input is still detected after a predetermined period of time has lapsed.

16. The method of claim 14 further comprising:
detecting a movement of the tactile input to a different location on the touch sensitive input device; and
causing an output to be generated at the different location, wherein the output comprises a display of an icon associated with a subsequent item of the sequence of items.

17. The method of claim 14, wherein respective items of the sequence of items have a different tactile feedback associated therewith, and wherein causing an output to be generated further comprises causing the tactile feedback associated with an item of the sequence of items to be generated.

18. The method of claim 13 further comprising:
determining a location on the touch sensitive input device of an icon associated with an expected item; and
determining the direction of the determined location of the icon from the location of the tactile input, wherein causing the output to be generated further comprises causing a tactile feedback to be generated proximate the location of the tactile input that indicates the determined direction.

19. The method of claim 13 further comprising:
causing a dialogue box to be displayed, said dialogue box comprising a portion the user can select in order to access the dialogue box, and wherein causing an output to be generated at the determined location further comprises displaying the dialogue box such that the portion is proximate the determined location.

20. A computer program product comprising at least one computer-readable storage medium having computer-readable program code portions stored therein, the computer-readable program code portions comprising:
a first executable portion for detecting a tactile input on a touch sensitive input device;
a second executable portion for determining a location of the tactile input; and
a third executable portion for causing an output to be generated proximate the determined location, wherein at least one of an orientation of the output or the output itself is determined based at least in part on an anticipated action by a user.

21. The computer program product of claim 20, wherein the computer-readable program code portions further comprise:
a fourth executable portion for determining a sequence of one or more items, and wherein the third executable portion is further configured to cause an icon associated with a first item of the sequence of items to be displayed.

22. The computer program product of claim 21, wherein the third executable portion is further configured to cause an icon associated with a subsequent item of the sequence of items to be displayed at the location if the tactile input is still detected after a predetermined period of time has lapsed.

23. The computer program product of claim 21, wherein the computer-readable program code portions further comprise:
a fifth executable portion for detecting a movement of the tactile input to a different location on the touch sensitive input device; and
a sixth executable portion for causing an output to be generated at the different location, wherein the output comprises a display of an icon associated with a subsequent item of the sequence of items.

24. The computer program product of claim 21, wherein respective items of the sequence of items have a different tactile feedback associated therewith, and wherein the third executable portion is further configured to cause the tactile feedback associated with an item of the sequence of items to be generated.

25. The computer program product of claim 20, wherein the computer-readable program code portions further comprise:
a fourth executable portion for determining a location on the touch sensitive input device of an icon associated with an expected item; and
a fifth executable portion for determining the direction of the determined location of the icon from the location of the tactile input, wherein the third executable portion is further configured to cause a tactile feedback to be generated proximate the location of the tactile input that indicates the determined direction.

26. The computer program product of claim 21, wherein the computer-readable program code portions further comprise:
a fourth executable portion for causing a dialogue box, said dialogue box comprising a portion the user can select in order to access the dialogue box, and wherein the third executable portion is further configured to display the dialogue box such that the portion is proximate the determined location.

27. An apparatus comprising:
means for detecting a tactile input on a touch sensitive input device;
means for determining a location of the tactile input; and
means for causing an output to be generated proximate the determined location, wherein at least one of an orientation of the output or the output itself is determined based at least in part on an anticipated action by a user.
